(19) United States
(12) Patent Application Publication
(10) Pub. No.: US 2026/0004138 A1
(43) Pub. Date: Jan. 1, 2026

(54) Compression and training method and apparatus for defect detection model

(71) Applicant: DSTEK CO., LTD., Suzhou Pilot Free Trade Zone Suzhou (CN)

(72) Inventors: Xu HAN, Suzhou Pilot Free Tradezone Suzhou (CN); Cong YAN, Suzhou Pilot Free Trade Zone Suzhou (CN)

(21) Appl. No.: 19/125,916

(22) PCT Filed: Sep. 5, 2023
(86) PCT No.: PCT/CN2023/116994

§ 371 Date: Apr. 30, 2025

(30) Foreign Application Priority Data
Sep. 5, 2022 (CN) 202211075557.2

(51) Int. Cl. G06N 3/09; G06N 3/0464; G06T 3/40; G06T 7/00; G06V 10/74; G06V 10/82; G06V 20/70

(52) U.S. Cl. CPC G06N 3/09; G06N 3/0464; G06T 3/40; G06T 7/0008; G06V 10/761; G06V 10/82; G06V 20/70; G06T 2207/20081; G06T 2207/20084; G06T 2207/30108

(57) ABSTRACT

Disclosed in the present application are a compression and training method and apparatus for a defect detection model. The method comprises: obtaining, by means of segmentation labeling, a segmentation labeling factor matrix of each sample image; inputting each sample image into both a first defect detection model and a second defect detection model, and extracting first feature maps outputted by target convolutional layers in the first defect detection model and second feature maps outputted by corresponding target convolutional layers in the second defect detection model; and calculating, by using the segmentation labeling factor matrix, corrected distances between corresponding feature vectors of the first feature maps and the second feature maps, and calculating, as a first loss function, the sum of the corrected distances between all the feature vectors of the first feature maps and the second feature maps. The present embodiment can improve the accuracy of detecting tiny product appearance defects by means of a compressed defect detection model.

### CROSS-REFERENCE TO RELATED APPLICATIONS

The present disclosure claims the priority to the Chinese patent application with the filing number 202211075557.2 filed on Sep. 5, 2022 with the China National Intellectual Property Administration and entitled “COMPRESSION TRAINING METHOD AND APPARATUS FOR DEFECT DETECTION MODEL”, the contents of which are incorporated herein by reference in entirety.

### TECHNICAL FIELD

The present disclosure relates to the technical field of defect detection based on machine vision, and specifically to a compression training method and apparatus for a defect detection model.

### BACKGROUND ART

With the development of image processing and artificial intelligence technologies, it has become common practice in the industry to train deep learning-based defect detection models and deploy the same in industrial smart cameras on production line stations for product surface defect detection. Due to typically complex network architectures and heavy computational burden, deep learning-based defect detection models require relatively high hardware computing environment and are not applicable to direct deployment on mobile devices in low-computing environment, such as handheld cameras.

In order to deploy the deep learning-based defect detection models in low-computing power mobile devices, so that rapid detection of product surface defects can be performed based on mobile devices such as handheld cameras, techniques such as pruning, quantification, and knowledge distillation are typically adopted in the industry to perform model compression on models, thereby obtaining a lightweight deep learning-based defect detection model for deployment and accelerated inference. Knowledge distillation uses supervision information (i.e., knowledge) of a large-scale teacher model to train a lightweight student model, hoping to achieve relatively good performance and accuracy. Supervision information of the large-scale teacher model may come from output feature knowledge or middle layer feature knowledge of the teacher model.

However, in real-world industry practice of product appearance defect detection, challenges of limited product appearance defect samples and micro defect dimensions are often encountered. Existing lightweight deep learning-based defect detection models, which is obtained through model compression like knowledge distillation, exhibit reduced accuracy in detecting product appearance micro-defects with limited defect samples. Therefore, there is an urgent need for an improved method to address this problem, so as to realize accurate and rapid classification and detection of product appearance defects using deep learning-based defect detection models on low-computing power mobile devices.

### SUMMARY

In view of this, the present disclosure provides a compression training method and apparatus for a defect detection model, so as to enhance feature sensitivity of the distilled defect detection model on a defect image containing micro-defects, and improve the accuracy of the compressed defect detection model in detecting the product appearance micro-defects.

In the first aspect, an embodiment of the present disclosure provides a compression training method for a defect detection model, including steps of:
performing segmentation labeling of a defect area on a sample image dataset of a product appearance, so as to obtain a segmentation labeling factor matrix of each sample image;
inputting each sample image in the sample image dataset into a first defect detection model and a second defect detection model, respectively, and extracting a first feature map output by a target convolutional layer in the first defect detection model and a second feature map output by a corresponding target convolutional layer in the second defect detection model, respectively, where the second defect detection model is a deep convolutional neural network model that has the same general architecture as the pre-trained first defect detection model but with fewer layers;
calculating distances between corresponding feature vectors in the first feature map and the second feature map, using corresponding elements in the segmentation labeling factor matrix to correct the distances, so as to obtain corrected distances between corresponding feature vectors in the first feature map and the second feature map, and calculating a sum of the corrected distances between all the feature vectors in the first feature map and the second feature map as the first loss function; and
performing, on the basis of minimizing the first loss function, iterative training on the second defect detection model, so as to obtain the distilled second defect detection model.

In optional embodiments, the segmentation labeling factor matrix is configured to label factor values corresponding to individual pixel points in each sample image, where the factor values for pixel points in the defect area of each sample image and the factor values for pixel points in a non-defect area of each sample image are opposite numbers to each other.

In optional embodiments, the step of calculating distances between corresponding feature vectors in the first feature map and the second feature map, and using corresponding elements in the segmentation labeling factor matrix to correct the distances, so as to obtain corrected distances between corresponding feature vectors in the first feature map and the second feature map includes:
calculating a squared Euclidean distance of respective normalized vectors of corresponding feature vectors of the first feature map and the second feature map; and
calculating a product of the squared Euclidean distance and a corresponding element in the segmentation labeling factor matrix, so as to obtain the corrected distance between corresponding feature vectors of the first feature vector and the second feature vector.

In optional embodiments, the step of calculating a product of the squared Euclidean distance and a corresponding element in the segmentation labeling factor matrix, so as to obtain the corrected distance between corresponding feature vectors of the first feature vector and the second feature vector includes:
performing a size transformation operation on the segmentation labeling factor matrix, so as to obtain the transformed segmentation labeling factor matrix after alignment with sizes of the first feature map and the second feature map; and
calculating a product of the squared Euclidean distance and a corresponding element in the transformed segmentation labeling factor matrix, so as to obtain the corrected distance between corresponding feature vectors of the first feature map and the second feature map.

In optional embodiments, the method further includes:
after inputting each sample image into the second defect detection model, obtaining a defect classification probability vector output by the second defect detection model;
calculating a cross entropy loss between the defect classification probability vector and a classification labeling vector of the sample image, as a second loss function; and
calculating a weighted sum of the first loss function and the second loss function as a total loss function, and performing, on the basis of minimizing the total loss function, the iterative training on the second defect detection model, so as to obtain the distilled second defect detection model.

In optional embodiments, the method further includes: for a plurality of sample images of each batch in the sample image dataset, calculating an average value of the total loss function of each sample image input into the first defect detection model and the second defect detection model, and performing the iterative training on the second defect detection model on the basis of minimizing the average value of the total loss function.

In optional embodiments, the method further includes: if the first feature map and the second feature map are inconsistent in size, performing downsampling on the first feature map or performing upsampling on the second feature map, so as to align the first feature map and the second feature map in size.

In the second aspect, another embodiment of the present disclosure further provides a compression training method for a defect detection model, including:
performing segmentation labeling of a defect area on a sample image dataset of a product appearance, so as to obtain a segmentation labeling factor matrix of each sample image;
inputting each sample image in the sample image dataset into a first defect detection model and a second defect detection model, respectively, and extracting a plurality of first feature maps output by a plurality of target convolutional layers in the first defect detection model and a plurality of second feature maps output by a plurality of corresponding target convolutional layers in the second defect detection model, respectively, where the second defect detection model is a deep convolutional neural network model that has the same general architecture as the pre-trained first defect detection model but with fewer layers;
calculating distances between corresponding feature vectors in each first feature map and corresponding second feature map among the plurality of first feature maps and second feature maps in sequence, using corresponding elements in the segmentation labeling factor matrix to correct the distances, so as to obtain corrected distances between corresponding feature vectors in each first feature map and corresponding second feature map, calculating a sum of the corrected distances between all feature vectors in each first feature map and corresponding second feature map, and calculating an accumulation of the sum of the corrected distances between each first feature map and corresponding second feature map among the plurality of first feature maps and second feature maps as the first loss function; and
performing, on the basis of minimizing the first loss function, iterative training on the second defect detection model, so as to obtain the distilled second defect detection model.

In the third aspect, another embodiment of the present disclosure further provides a compression training apparatus for a defect detection model, including:
a segmentation labeling unit, configured to perform segmentation labeling of a defect area on a sample image dataset of a product appearance, so as to obtain a segmentation labeling factor matrix of each sample image;
a feature extraction unit, configured to input each sample image in the sample image dataset into a first defect detection model and a second defect detection model, respectively, and extract a first feature map output by a target convolutional layer in the first defect detection model and a second feature map output by a corresponding target convolutional layer in the second defect detection model, respectively, where the second defect detection model is a deep convolutional neural network model that has the same general architecture as the pre-trained first defect detection model but with fewer layers;
a first loss evaluation unit, configured to calculate distances between corresponding feature vectors in the first feature map and the second feature map, use corresponding elements in the segmentation labeling factor matrix to correct the distances, so as to obtain corrected distances between corresponding feature vectors in the first feature map and the second feature map, and calculate a sum of the corrected distances between all feature vectors in the first feature map and the second feature map as the first loss function; and
a first iterative training unit, configured to, on the basis of minimizing the first loss function, perform iterative training on the second defect detection model, so as to obtain the distilled second defect detection model.

In the fourth aspect, another embodiment of the present disclosure further provides a compression training apparatus for a defect detection model, including:
a segmentation labeling unit, configured to perform segmentation labeling of a defect area on a sample image dataset of a product appearance, so as to obtain a segmentation labeling factor matrix of each sample image;
a feature extraction unit, configured to input each sample image in the sample image dataset into the first defect detection model and the second defect detection model, respectively, and extract a plurality of first feature maps output by a plurality of target convolutional layers in the first defect detection model and a plurality of second feature maps output by a plurality of corresponding target convolutional layers in the second defect detection model, respectively, where the second defect detection model is a deep convolutional neural network model that has the same general architecture as the pre-trained first defect detection model but with fewer layers;
a first loss evaluation unit, configured to calculate distances between corresponding feature vectors in each first feature map and corresponding second feature map among the plurality of first feature maps and second feature maps in sequence, use corresponding elements in the segmentation labeling factor matrix to correct the distances, so as to obtain corrected distances between corresponding feature vectors in each first feature map and the corresponding second feature map, calculate a sum of the corrected distances between all feature vectors in each first feature map and corresponding second feature map, and calculate an accumulation of the sum of the corrected distances between each first feature map and corresponding second feature map among the plurality of first feature maps and second feature maps as the first loss function; and
a first iterative training unit, configured to, on the basis of minimizing the first loss function, perform iterative training on the second defect detection model, so as to obtain the distilled second defect detection model.

The embodiments of the present disclosure at least can achieve the following beneficial effects: by correcting the distances between all feature vectors of the first feature map and the second feature map with the factor values in the segmentation labeling factor matrix, when performing the compression training on the defect detection model on the basis of minimizing the first loss function, the feature sensitivity of the distilled defect detection model on the defect image containing micro-defects is enhanced, and the accuracy of the compressed defect detection model in detecting the micro-defects in product appearance is improved.

### BRIEF DESCRIPTION OF DRAWINGS

In order to describe technical solutions of embodiments of the present disclosure more clearly, drawings that need to be used in the embodiments of the present disclosure will be briefly introduced below. It should be understood that the drawings only show some of the embodiments of the present disclosure, but should not be regarded as limitation to the scope.

FIG. 1 is a schematic flowchart of a compression training method for a defect detection model according to an embodiment of the present disclosure;

FIG. 2 is a schematic diagram of a network structure of a first defect detection model ResNet101 and a second defect detection model ResNet18 according to an embodiment of the present disclosure;

FIG. 3 is a schematic flowchart of a compression training method for a defect detection model according to another embodiment of the present disclosure;

FIG. 4 is a schematic flowchart of a compression training method for a defect detection model according to another embodiment of the present disclosure;

FIG. 5 is a structural schematic diagram of a compression training apparatus for a defect detection model according to an embodiment of the present disclosure;

FIG. 6 is a structural schematic diagram of a compression training apparatus for a defect detection model according to another embodiment of the present disclosure; and

FIG. 7 is a partial structural schematic diagram of the compression training apparatus for the defect detection model according to another embodiment of the present disclosure.

### DETAILED DESCRIPTION OF EMBODIMENTS

In order to make objectives, technical solutions and advantages of the present disclosure clearer, the technical solutions in the embodiments of the present disclosure will be described clearly and completely below in conjunction with drawings in the embodiments of the present disclosure. However, it should be understood that only some but not all embodiments of the present disclosure are described. The detailed descriptions of the embodiments of the present disclosure are not intended to limit the scope of the present disclosure claimed. All of other embodiments obtained by those skilled in the art based on the embodiments of the present disclosure without using inventive efforts shall fall within the scope of protection of the present disclosure.

It should be indicated that the terms such as “first” and “second” in the description and the claims of the present disclosure are merely used for distinguishing similar objects, rather than describing a specific order or sequence, and should not be construed as indicating or implying importance in the relativity.

As mentioned in the preceding, in real-world industry practice of product appearance defect detection, challenges of limited product appearance defect samples and micro defect dimensions are often encountered. Existing solutions of lightweight deep learning-based defect detection models, obtained through model compression using knowledge distillation, exhibit reduced accuracy in detecting such product appearance micro-defects with limited defect samples. In this scenario, as a pre-trained first deep learning-based defect detection model as a teacher model is trained with more non-defect image datasets and few defect image datasets, this model has superior feature sensitivity for non-defect images than for defect images containing micro-defects, so that features extracted by this model from defect images containing micro-defects exhibit insufficient discriminability from features extracted from non-defect images on the whole. In processes of performing knowledge distillation-based training and learning using the teacher model to obtain a lightweight second deep learning-based defect detection model, the second deep learning-based defect detection model learns feature knowledge output from the teacher model, so that features extracted by the second deep learning-based defect detection model from defect images containing micro-defects also have the above problem, that is, they fail to exhibit significant discriminability from features extracted from non-defect images. When the second deep learning-based defect detection model compressed by the knowledge distillation is deployed in a mobile device and is used for detecting product appearance defects, accuracy of classifying and detecting product appearance micro-defects will be compromised.

In view of this, the present disclosure provides a compression training method and apparatus for a defect detection model. By incorporating segmentation labeling factors for an image defect area into a compression training process of knowledge distillation of the defect detection model, the feature sensitivity for defect images containing micro-defects is enhanced, and the accuracy of the compressed defect detection model in detecting micro-defects in the product appearance is improved.

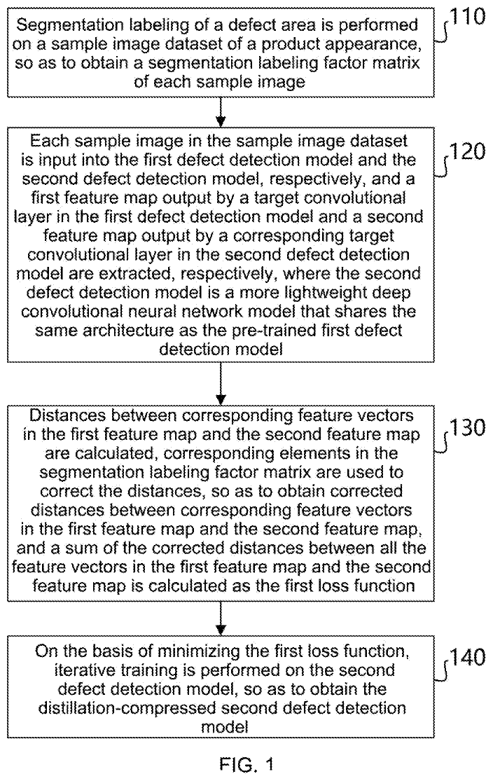

FIG. 1 is a schematic flowchart of the compression training method for the defect detection model according to an embodiment of the present disclosure. As shown in FIG. 1, the compression training method for the defect detection model in an embodiment of the present disclosure includes steps as follows.

At step S110, segmentation labeling of a defect area is performed on a sample image dataset of a product appearance, so as to obtain a segmentation labeling factor matrix of each sample image.

In the present step, it is preferred that (firstly) the segmentation labeling of the defect area is performed on the sample image dataset of the product appearance, so as to obtain the segmentation labeling factor matrix of each sample image. The segmentation labeling factor matrix of each sample image is configured to label factor values corresponding to individual pixel points in each sample image, and assign distinct factor values to pixel points in the defect area of each sample image versus those of pixel points in a non-defect area of the sample image, so as to correct distances between a first feature map extracted from a first defect detection model and a second feature map extracted from a second defect detection model in a subsequent step.

In an embodiment, the segmentation labeling factor matrix is sized corresponding to a pixel size of each sample image, and each pixel point in the sample image is assigned a factor value at a corresponding pixel position in the segmentation labeling factor matrix. Herein, the factor values for the pixel points in the defect area and the factor values for the pixel points in the non-defect area are opposite numbers to each other. Assuming that the segmentation labeling factor matrix of each sample image is represented as A, for each pixel point (i, j), the factor value A (i, j) of the pixel point is represented as:

$$A ( i , j ) = \{ \begin{matrix}a , & ( i , j ) ∈ {R}^{d} \\ - a , & ( i , j ) ∈ {R}^{n}\end{matrix}$$

Herein, 0<a≤1, R^{d} denotes a set of pixel points in the non-defect area of the sample image, and R″ denotes a set of pixel points in the defect area of the sample image. The meaning of the above expression is that a positive factor value a is assigned to the pixel point in the non-defect area of the sample image, and a negative factor value-a is assigned to the pixel point in the defect area of the sample image. In the present embodiment, by assigning a factor value opposite to the factor value of the pixel point in the non-defect area to the pixel point in the defect area of the sample image, when performing distillation learning and training on the second defect detection model from the first defect detection model, distances between feature points corresponding to the defect area of the sample image in a first loss function can be increased, and the feature sensitivity of the distilled second defect detection model on the defect images containing micro-defects can be enhanced, which will be further described below in conjunction with subsequent steps.

At step S120, each sample image in the sample image dataset is input into the first defect detection model and the second defect detection model, respectively, and a first feature map output by a target convolutional layer in the first defect detection model and a second feature map output by a corresponding target convolutional layer in the second defect detection model are extracted, respectively, where the second defect detection model is a deep convolutional neural network model that has the same general architecture (residual structure) as the pre-trained first defect detection model but with fewer layers.

In the present step, the pre-trained first defect detection model is selected as a teacher model, and a randomly initialized second defect detection model is selected as a student model. Herein, the first defect detection model is a large-scale deep convolutional neural network model, and the second defect detection model is a deep convolutional neural network model that has the same general architecture as the first defect detection model but with fewer layers. The second defect detection model, as a compressed model obtained by performing distillation learning on the first defect detection model, is ultimately deployed into a mobile device for performing classification and detection on product appearance defect images. In an embodiment, the first defect detection model can be selected from deep residual network models ResNet50, ResNet101, ResNet152, etc., and the second defect detection model can be selected from the deep residual network model ResNet18. It should be understood that the deep residual network models are only exemplary optional implementations of the first defect detection model and the second defect detection model, while the first defect detection model and the second defect detection model are not limited to the deep residual network models in embodiments of the present disclosure, and other deep convolutional neural network models suitable for defect classification and detection, such as Desnet and VGG network models, are also applicable to different embodiments of the present disclosure.

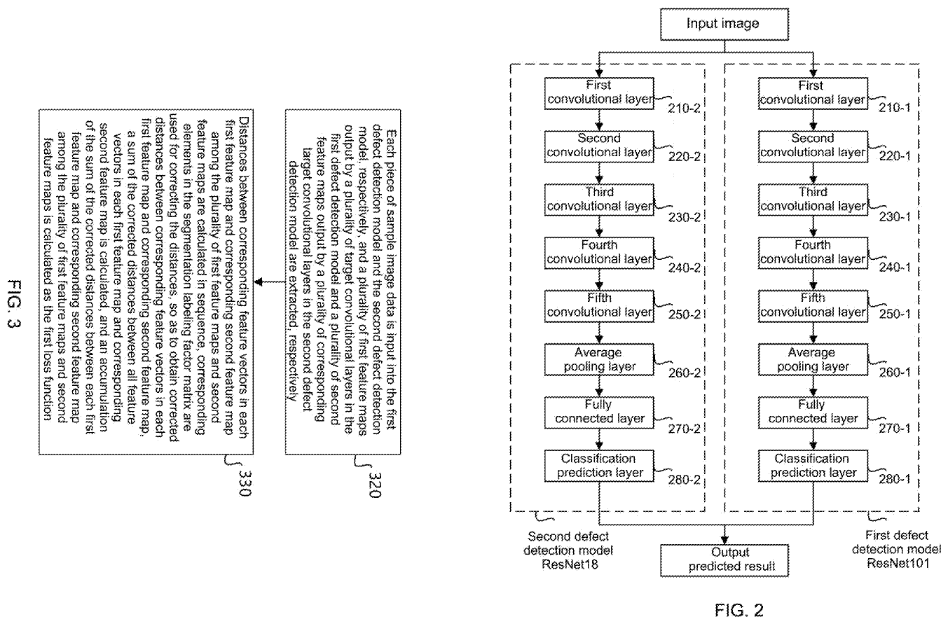

In an embodiment, as an example, the present embodiment can select deeper ResNet101 as the first defect detection model, and shallower ResNet18 as the second defect detection model. FIG. 2 shows a schematic diagram of a network structure of the first defect detection model ResNet101 and the second defect detection model ResNet18. As shown in FIG. 2, both ResNet101 as the first defect detection model and ResNet18 as the second defect detection model have the same architecture, that is, each includes five convolutional layer parts. The five convolutional layers of ResNet101 are a first convolutional layer 210-1 (conv1), a second convolutional layer 220-1 (conv2_x), a third convolutional layer 230-1 (conv3_x), a fourth convolutional layer 240-1 (conv4_x) and a fifth convolutional layer 250-1 (conv5_x), respectively. The five convolutional layers of ResNet18 are a first convolutional layer 210-2 (conv1), a second convolutional layer 220-2 (conv2_x), a third convolutional layer 230-2 (conv3_x), a fourth convolutional layer 240-2 (conv4_x) and a fifth convolutional layer 250-2 (conv5_x), respectively.

With regard to the first defect detection model ResNet101 and the second defect detection model ResNet18, the first convolutional layers 210-1 and 210-2 (conv1) are both pre-processing layers, with a convolution kernel size of 7×7 and 64 convolution kernels, pre-process a sample image input, and output a feature map of 112×112×64, where 112×112 respectively represent a width and a height of the feature map output, and 64 is the number of channels of the feature map output.

For the first defect detection model ResNet101, the second convolutional layer 220-1 (conv2_x), the third convolutional layer 230-1 (conv3_x), the fourth convolutional layer 240-1 (conv4_x) and the fifth convolutional layer 250-1 (conv5_x) include 3, 4, 23, and 3 convolutional blocks, respectively, where each convolutional block includes two 1×1 convolution units and one 3×3 convolution unit. For the second defect detection model ResNet18, the second convolutional layer 220-2 (conv2_x), the third convolutional layer 230-2 (conv3_x), the fourth convolutional layer 240-2 (conv4_x) and the fifth convolutional layer 250-2 (conv5_x) include 2, 2, 2, and 2 convolutional blocks, respectively, where each convolutional block includes two 3×3 convolution units. After processing of each convolutional layer in sequence, the second convolutional layers 220-1 and 220-2 (conv2_x) output feature maps of 56×56×256, the third convolutional layers 230-1 and 230-2 (conv3_x) output feature maps of 28×28×512, the fourth convolutional layers 240-1 and 240-2 (conv4_x) output feature maps of 14×14×1024, and the fifth convolutional layers 250-1 and 250-2 (conv5_x) output feature maps of 7×7×2048.

After the processing of the above five convolutional layers, ResNet101 and ResNet18 further perform subsequent processing respectively through average pooling layers 260-1 and 260-2, fully connected layers 270-1 and 270-2, and softmax layers 280-1 and 280-2, and output a prediction classification result of the sample image data, where the prediction classification result is presented in the form of a defect classification probability vector.

In the present step, firstly, each sample image in the sample image dataset is input into the pre-trained first defect detection model and the randomly initialized second defect detection model, respectively, and then the first feature map output by the target convolutional layer in the first defect detection model and the second feature map output by the corresponding target convolutional layer in the second defect detection model are extracted, respectively. In an embodiment of the present disclosure, last convolutional layers in the first defect detection model and in the second defect detection model can be selected as the target convolutional layers, and the feature maps output thereby are extracted.

Assuming that any sample image in the sample image dataset is represented as Iₛ, the first feature map output by the target convolutional layer of the first defect detection model is M₁(Iₛ), the second feature map output by the target convolutional layer of the second defect detection model is represented as M₂(Iₛ), where M₁(Iₛ) and M₂(Iₛ) are sized as W×H×C, where W is a width of the feature map, H is a height of the feature map, and C is the number of channels of the feature map.

At step S130, distances between corresponding feature vectors in the first feature map and the second feature map are calculated, corresponding elements in the segmentation labeling factor matrix are used to correct the distances, so as to obtain corrected distances between corresponding feature vectors in the first feature map and the second feature map, and a sum of the corrected distances between all the feature vectors in the first feature map and the second feature map is calculated as the first loss function.

In the present step, in the feature maps output by the convolutional layers of the deep convolutional neural network model, as a corresponding feature vector can be extracted from each feature point, dimensionality of the feature vector is the number of channels of the feature map. Therefore, for a position (m, n) of each feature point in the first feature map and the second feature map, a first feature vector M₁(Iₛ)_{m,n} corresponding to this feature point can be extracted from the first feature map, a second feature vector M₂(Iₛ)_{m,n} corresponding to this feature point can be extracted from the second feature map, and the first feature vector and the second feature vector form a corresponding feature vector pair. Then, the distance between the first feature vector and the second feature vector can be calculated.

In an embodiment, the distance between the first feature vector and the second feature vector can be a squared Euclidean distance of respective normalized vectors of the first feature vector and the second feature vector. Specifically, assuming that the normalized vector of the first feature vector is denoted as M̅₁(Iₛ)_{m,n}, and the normalized vector of the second feature vector is denoted as M̅₂(Iₛ)_{m,n}, then:

$${{\overline{M}}_{1} ( {I}_{s} )}_{m , n} = {{M}_{1} ( {I}_{s} )}_{m , n} / {‖ {{M}_{1} ( {I}_{s} )}_{m , n} ‖}_{2} , \\ {{\overline{M}}_{2} ( {I}_{s} )}_{m , n} = {{M}_{2} ( {I}_{s} )}_{m , n} / {‖ {{M}_{2} ( {I}_{s} )}_{m , n} ‖}_{2} .$$

Herein, ∥M₁(Iₛ)_{m,n}∥₂ and ∥M₂(Iₛ)_{m,n}∥₂ denote L2-norms of the first feature vector and the second feature vector, respectively.

Then, the squared Euclidean distances E_{m,n} of respective normalized vectors of the first feature vector and the second feature vector can be calculated as shown in the following formula:

$${E}_{m , n} = {\sum }_{p} {( {{\overline{M}}_{1 , p} ( {I}_{s} )}_{m , n} - {{\overline{M}}_{2 , p} ( {I}_{s} )}_{m , n} )}^{2} .$$

Herein, M̅_{1,p}(Iₛ)_{m,n} and M̅_{2,p}(Iₛ)_{m,n} represent the p-th element of the respective normalized vectors of the first feature vector and the second feature vector, respectively.

Subsequently, after the squared Euclidean distance of respective normalized vectors of the first feature vector and the second feature vector is obtained by calculation, a product of the squared Euclidean distance and a corresponding element in the segmentation labeling factor matrix is calculated, so as to obtain the corrected distance between the first feature vector and the second feature vector.

In an embodiment, as the size of the segmentation labeling factor matrix is equal to the pixel size of the sample image, and different from the width and height of the first feature map and the second feature map, in embodiments of the present disclosure, a size transformation (resizing) operation can be performed on the segmentation labeling factor matrix, so as to align the size of the segmentation labeling factor matrix with the width and height W×H of the first feature map and the second feature map, which can be achieved by performing a scaling operation resize ( ) of nearest-neighbor interpolation or bilinear interpolation on the segmentation labeling factor matrix. Taking implementation of the scaling operation of nearest-neighbor interpolation as an example, a proportional scale-down operation is performed on element positions in the segmentation labeling factor matrix, thus mapping them to target element positions of the transformed segmentation labeling factor matrix, and the size of the transformed segmentation labeling factor matrix is transformed into W×H.

Correspondingly, the calculation of the product of the squared Euclidean distance and the corresponding element in the segmentation labeling factor matrix may include calculating a product of the squared Euclidean distance and a corresponding element in the transformed segmentation labeling factor matrix, so as to obtain the corrected distance between the first feature vector and the second feature vector. Specifically, assuming that the transformed segmentation labeling factor matrix is represented as A^{r}, both the first feature vector and the second feature vector corresponding to the feature point position (m, n) respectively in the first feature map and the second feature map can find the corresponding element A^{r}(m, n) in the transformed segmentation labeling factor matrix A^{r}, where this element is a correction factor of the distance between the first feature vector and the second feature vector. Therefore, the corrected distance

$${E}_{m , n}^{c}$$

between the first feature vector and the second feature vector can be represented by the following formula:

$${E}_{m , n}^{c} = {A}^{r} ( m , n ) {E}_{m , n} .$$

Subsequently, the sum of the corrected distances between the feature vectors in the first feature map and the second feature map at all feature point positions is taken as the first loss function Loss₁(Iₛ), namely,

$${Loss}_{1} ( {I}_{s} ) = {\sum }_{m = 1}^{W} {\sum }_{n = 1}^{H} {E}_{m , n}^{c}$$

At step S140, on the basis of minimizing the first loss function, iterative training is performed on the second defect detection model, so as to obtain the distilled second defect detection model.

In the present step, based on the first loss function obtained in the preceding steps, the iterative training can be performed on the second defect detection model on the basis of minimizing the first loss function, parameters of the second defect detection model are iteratively updated under specified learning rate and batch size conditions, thus ultimately yielding the proper distilled second defect detection model, where the compressed second defect detection model can be subsequently deployed to a target mobile device, to perform defect classification and detection on product appearance images.

In the present embodiment, as the above first loss function corrects the distances between the feature vectors in the first feature map and the second feature map at all feature point positions by the segmentation labeling factors in the segmentation labeling factor matrix, and the segmentation labeling factor matrix assigns positive factor values to the pixel points in the non-defect area of the sample image, assigns factor values opposite to the factor values of the pixel points in the non-defect area to the pixel points in the defect area of the sample image, when the distillation learning and training is performed on the second defect detection model on the basis of minimizing the first loss function, on the one hand, the distances between the non-defect image features extracted by the first defect detection model and the second defect detection model are reduced, thus enabling the non-defect image features extracted by the distilled second defect detection model to be as similar to those by the first defect detection model as possible; on the other hand, the distances between the defect image features extracted by the first defect detection model and the second defect detection model are increased, thus enabling the defect image features extracted from the defect images by the distilled second defect detection model to be significantly distinguished from that by the first defect detection model, thus the defect image features extracted from defect images by the second defect detection model exhibit significant discriminability from the features extracted from non-defect images, thereby enhancing feature sensitivity of the distilled second defect detection model on defect images containing micro-defects, and improving the accuracy of the compressed second defect detection model in detecting the product appearance micro-defects.

In an embodiment, if the size of the first feature map extracted by the first defect detection model is inconsistent with the size of the second feature map extracted by the second defect detection model, typically manifested as the size of the first feature map extracted by the first defect detection model being greater than the size of the second feature map extracted by the second defect detection model, it is necessary to perform downsampling on the first feature map or perform upsampling on the second feature map, so as to align the sizes of the first feature map and the second feature map, and then the above steps S130 and S140 are performed.

FIG. 3 is a method flowchart of a compression training method for a defect detection model according to another embodiment of the present disclosure. As shown in FIG. 3, the compression training method for the defect detection model in embodiments of the present disclosure, on the basis of any of the preceding embodiments, can further optimize and improve steps S120 and S130, and can obtain steps as follows.

At step S320, each sample image in the sample image dataset is input into the first defect detection model and the second defect detection model, respectively, and a plurality of first feature maps output by a plurality of target convolutional layers in the first defect detection model and a plurality of second feature maps output by a plurality of corresponding target convolutional layers in the second defect detection model are extracted, respectively, where the second defect detection model is a deep convolutional neural network model that has the same general architecture as the pre-trained first defect detection model but with fewer layers.

In steps of the present example, the pre-trained first defect detection model and the randomly initialized second defect detection model can be the same as those in the preceding embodiments, and will not be repeated herein.

In the present step, each piece of sample image data is input into the pre-trained first defect detection model and the randomly initialized second defect detection model, and a plurality of target convolutional layers are selected from the first defect detection model and the second defect detection model, respectively. In an embodiment, a plurality of target convolutional layers respectively selected may include several consecutive convolutional layers selected from the plurality of convolutional layers of each of the first defect detection model and the second defect detection model as the target convolutional layers. The network structure of the first defect detection model ResNet101 and the second defect detection model ResNet18 shown in FIG. 2 is still taken as an example. As an example, for instance, the first convolutional layer 210-1 (conv1) and the second convolutional layer 220-1 (conv2x) can be selected from the first defect detection model, the first convolutional layer 210-1 (conv1) and the second convolutional layer 220-1 (conv2x) can be selected from the second defect detection model as corresponding target convolutional layers, or the fourth convolutional layer 240-1 (conv4x) and the fifth convolutional layer 250-1 (conv5x) can be selected from the first defect detection model, and the fourth convolutional layer 240-2 (conv4x) and the fifth convolutional layer 250-2 (conv5x) can be selected from the second defect detection model respectively as corresponding target convolutional layers, and the like. In this way, a plurality of corresponding first feature maps and second feature maps can be extracted from the plurality of target convolutional layers in the first defect detection model and the second defect detection model, respectively.

At step S330, distances between corresponding feature vectors in each first feature map and corresponding second feature map among the plurality of first feature maps and second feature maps are calculated in sequence, corresponding elements in the segmentation labeling factor matrix are used for correcting the distances, so as to obtain corrected distances between corresponding feature vectors in each first feature map and corresponding second feature map, a sum of the corrected distances between all feature vectors in each first feature map and corresponding second feature map is calculated, and an accumulation of the sum of the corrected distances between each first feature map and corresponding second feature map among the plurality of first feature maps and second feature maps is calculated as the first loss function.

Specifically, assuming that L target convolutional layers are selected from the first defect detection model and the second defect detection model, respectively, and L first feature maps output and corresponding L second feature maps are respectively extracted from each target convolutional layer of the first defect detection model and the second defect detection model, where L is an integer greater than 1. Then, for an l-th first feature map and corresponding second feature map, 0<l≤L, the squared Euclidean distance between respective normalized vectors of the first feature vector and the second feature vector corresponding to a feature point position (m, n) between the l-th first feature map and corresponding second feature map is

$${E}_{m , n}^{l} ;$$

the corrected distance between the first feature vector and the second feature vector is represented as

$${E}_{m , n}^{c , l} ,$$

that is, the corrected distance is represented by a product of the squared Euclidean distance and a corresponding element in a size transformation matrix of the segmentation labeling factor matrix corresponding to the l-th first feature map and corresponding second feature map, as calculated by using the following formula:

$${E}_{m , n}^{c , l} = {A}^{r , l} ( m , n ) {E}_{m , n}^{l} .$$

Herein, A^{r,1}(m, n) is an element corresponding to the feature point position (m, n) in the size transformation matrix of the segmentation labeling factor matrix corresponding to the l-th first feature map and the corresponding second feature map. In addition, as the sizes of the feature maps output by the plurality of target convolutional layers are different, a corresponding size transformation operation needs to be performed on the segmentation labeling factor matrix for each first feature map, so as to align the size of the segmentation labeling factor matrix with widths and heights of respective first feature maps and second feature maps, respectively.

In this case, an accumulation of the sum of the corrected distances between each first feature map and corresponding second feature map among the plurality of first feature maps and second feature maps is taken as the first loss function, which can be calculated through the following formula:

$${Loss}_{1} ( {I}_{s} ) = {\sum }_{l = 1}^{L} {\sum }_{m = 1}^{{w}_{1}} {\sum }_{n = 1}^{{H}_{1}} {E}_{m , n}^{c , l}$$

Herein W₁ and H₁ represent the width and height dimensions of the l-th first feature map and the corresponding second feature map, respectively.

In the present embodiment, by accumulating the corrected distances between the plurality of first feature maps and the plurality of corresponding second feature maps extracted from the plurality of target convolutional layers in the first defect detection model and the second defect detection model, feature extraction characteristics of the plurality of middle convolutional layers in the first defect detection model and the second defect detection model can be considered synthetically, which can further facilitate the distillation learning between the first defect detection model and the second defect detection model, such that when the distillation learning and training is performed on the second defect detection model on the basis of minimizing the first loss function, while reducing the distances between the non-defect image features extracted by the first defect detection model and the second defect detection model, the distances between the defect image features extracted by the first defect detection model and the second defect detection model are increased, thus enabling the defect image features extracted from defect images by the second defect detection model to exhibit significant discriminability from the features extracted from non-defect images the second defect detection model to remarkably distinguish the defect image features extracted from the defect images from the features extracted from the non-defect images, thereby further enhancing the feature sensitivity of the distilled second defect detection model on defect images containing micro-defects, and further improving the accuracy of the compressed second defect detection model in detecting the product appearance micro-defects.

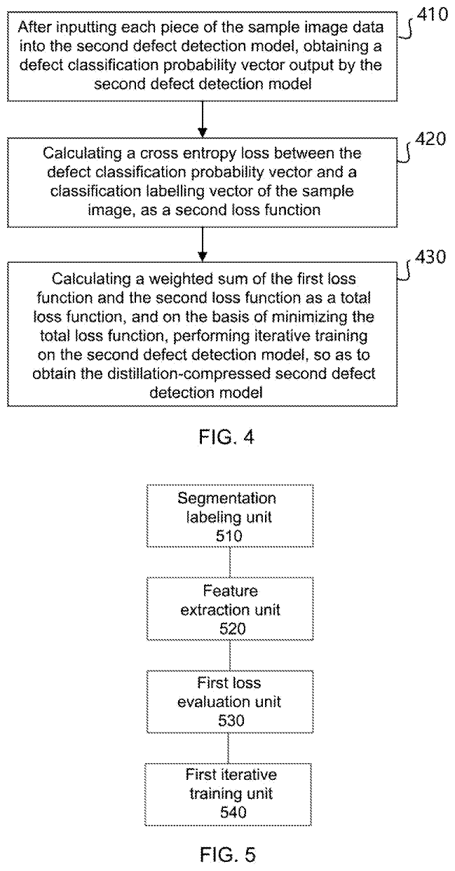

In some embodiments, as shown in FIG. 4, the method in embodiments of the present disclosure further may include:

step S410, after inputting each of the sample images into the second defect detection model, obtaining a defect classification probability vector output by the second defect detection model;

step S420, calculating a cross entropy loss between the defect classification probability vector and a classification labeling vector of the sample image data, as a second loss function; and

step S430, calculating a weighted sum of the first loss function and the second loss function as a total loss function, and on the basis of minimizing the total loss function, performing iterative training on the second defect detection model, so as to obtain the distilled second defect detection model.

In the present embodiment, the defect classification probability vector output by the second defect detection model is obtained while performing the distillation learning and training on the second defect detection model. The defect classification probability vector may be a probability vector [c₁, c₂, . . . , c_{K}] output from the softmax layer 280-2 as shown in FIG. 2, where K is the number of classifications composed of classifications of non-defect images and classifications of a plurality of defect images, and the probability vector represents a predicted classification probability of each sample image. The cross entropy loss between the defect classification probability vector of each sample image and a classification labeling vector (classification real value) of the sample image data is taken as a second loss function Loss₂(Iₛ). Then, a weighted sum of the first loss function and the second loss function is calculated as the total loss function, i.e., Lossₜₒₜₐₗ(Iₛ)=Loss₁(Iₛ)+α Loss₂(Iₛ), where α is a weight coefficient of the first loss function and the second loss function, and can be adjusted according to an empirical value in a training process. Subsequently, iterative training can be performed on the second defect detection model on the basis of minimizing the weighted sum of the first loss function and the second loss function, and parameters of the second defect detection model are updated, so as to obtain the distilled second defect detection model.

In the distillation learning and training of the second defect detection model of the present embodiment, on the basis of the preceding first loss function, predicted loss of the second defect detection model itself is further taken into consideration, which can assist in improving the accuracy of predicting micro-defects in the product appearance by the second defect detection model after the distillation learning.

In an embodiment, the method further includes:
for a plurality of sample images of each batch in the sample image dataset, calculating an average value of the total loss function of each sample image input into the first defect detection model and the second defect detection model, and on the basis of minimizing the average value of the total loss function, performing the iterative training on the second defect detection model.

Assuming that the batch size of the model training is N, a plurality of sample images {I₁, I₂, . . . , I_{N}} of each batch are input in sequence into the first defect detection model and the second defect detection model for training, and the average value of the total loss function of each batch can be calculated as:

$${Loss}_{avg} = \frac{1}{N} {\sum }_{s = 1}^{N} {Loss}_{total} ( {I}_{s} )$$

In this way, on the basis of minimizing the average value Loss_{avg} of the total loss function of each batch, the iterative training is performed on the second defect detection model, and parameters of the second defect detection model are updated, so as to obtain the distilled second defect detection model.

FIG. 5 is a structural schematic diagram of a compression training apparatus for a defect detection model according to an embodiment of the present disclosure. As shown in FIG. 5, the compression training apparatus for the defect detection model in an embodiment of the present disclosure includes module units as follows:
a segmentation labeling unit 510, configured to perform segmentation labeling of a defect area on a sample image dataset of a product appearance, so as to obtain a segmentation labeling factor matrix of each sample image;
a feature extraction unit 520, configured to input each sample image in the sample image dataset into a first defect detection model and a second defect detection model, respectively, and extract a first feature map output by a target convolutional layer in the first defect detection model and a second feature map output by a corresponding target convolutional layer in the second defect detection model, respectively, where the second defect detection model is a deep convolutional neural network model that has the same general architecture as the pre-trained first defect detection model but with fewer layers;
a first loss evaluation unit 530, configured to calculate distances between corresponding feature vectors in the first feature map and the second feature map, use corresponding elements in the segmentation labeling factor matrix to correct the distances, so as to obtain corrected distances between corresponding feature vectors in the first feature map and the second feature map, and calculate a sum of the corrected distances between all the feature vectors in the first feature map and the second feature map as the first loss function; and
a first iterative training unit 540, configured to, on the basis of minimizing the first loss function, perform iterative training on the second defect detection model, so as to obtain the distilled second defect detection model.

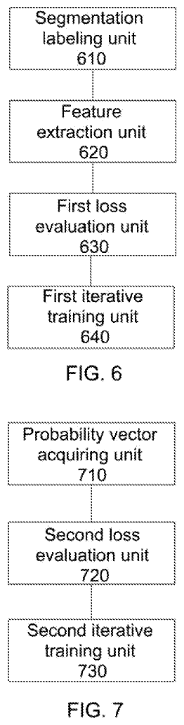

FIG. 6 is a structural schematic diagram of a compression training apparatus for a defect detection model according to another embodiment of the present disclosure. As shown in FIG. 6, the compression training apparatus for the defect detection model in an embodiment of the present disclosure includes module units as follows.
a segmentation labeling unit 610, configured to perform segmentation labeling of a defect area on a sample image dataset of a product appearance, so as to obtain a segmentation labeling factor matrix of each sample image;
a feature extraction unit 620, configured to input each sample image in the sample image dataset into the first defect detection model and the second defect detection model, respectively, and extract a plurality of first feature maps output by a plurality of target convolutional layers in the first defect detection model and a plurality of second feature maps output by a plurality of corresponding target convolutional layers in the second defect detection model, respectively, where the second defect detection model is a deep convolutional neural network model that has the same general architecture as the pre-trained first defect detection model but with fewer layers;
a first loss evaluation unit 630, configured to calculate distances between corresponding feature vectors in each first feature map and corresponding second feature map among the plurality of first feature maps and second feature maps in sequence, use corresponding elements in the segmentation labeling factor matrix to correct the distances, so as to obtain corrected distances between corresponding feature vectors in each first feature map and the corresponding second feature map, calculate a sum of the corrected distances between all the feature vectors in each first feature map and the corresponding second feature map, and calculate an accumulation of the sum of the corrected distances between each first feature map and corresponding second feature map among the plurality of first feature maps and second feature maps as the first loss function; and
a first iterative training unit 640, configured to, on the basis of minimizing the first loss function, perform iterative training on the second defect detection model, so as to obtain the distilled second defect detection model.

In an embodiment, as shown in FIG. 7, an embodiment of the present disclosure can further include:
a probability vector acquiring unit 710, configured to, after inputting each of the sample images into the second defect detection model, obtain a defect classification probability vector output by the second defect detection model;
a second loss evaluation unit 720, configured to calculate a cross entropy loss between the defect classification probability vector and a classification labeling vector of the sample image as a second loss function; and
a second iterative training unit 730, configured to calculate a weighted sum of the first loss function and the second loss function as a total loss function, and perform, on the basis of minimizing the total loss function, iterative training on the second defect detection model, so as to obtain the distilled second defect detection model.

In an embodiment, the apparatus further includes:
a third iterative training unit, configured to, for a plurality of sample images of each batch in the sample image dataset, calculate an average value of the total loss function of each sample image input into the first defect detection model and the second defect detection model, and perform, on the basis of minimizing the average value of the total loss function, the iterative training on the second defect detection model.

It should be noted that, those skilled in the art could understand that different embodiments, illustration thereof and technical effects achieved as described in the method embodiments of the present disclosure are also applicable to the apparatus embodiments of the present disclosure, which are not repeated herein again.

The embodiments of the present disclosure, by incorporating the segmentation labeling factors for the image defect area into the compression training process of knowledge distillation of the deep learning-based defect detection model, enhance the feature sensitivity for defect images containing micro-defects, and improve the accuracy of the compressed, deep learning-based defect detection model in detecting micro-defects in the product appearance.

The present disclosure can be implemented by software, hardware or a combination of software and hardware. When implemented as a computer software program, the computer software program may be installed in a memory of a computing device and executed by one or more processors so as to implement corresponding functions.

Further, the embodiments of the present disclosure may further include a computer-readable medium. The computer-readable medium stores a program instruction. In such embodiment, when the computer-readable storage medium is loaded in a computing apparatus, the program instruction can be executed by one or more processors so as to to execute the method steps described in any embodiment of the present disclosure.

Further, the embodiments of the present disclosure may further include a computer program product, including a computer-readable medium loading a program instruction. In such embodiment, the program instruction can be executed by one or more processors so as to execute the method steps described in any embodiment of the present disclosure.

The exemplary embodiments of the present disclosure are described in the above. It should be understood that the above exemplary embodiments are non-limiting, but illustrative, and the scope of protection of the present disclosure is not limited thereto. It should be understood that those skilled in the art could make modifications and variations to the embodiments of the present disclosure without departing from the spirit and scope of the present disclosure, and these modifications and variations shall fall within the scope of protection of the present disclosure.

1. A compression training method for a defect detection model, comprising steps of:
performing segmentation labeling of a defect area on a sample image dataset of a product appearance, so as to obtain a segmentation labeling factor matrix of each sample image;
inputting each sample image in the sample image dataset into a first defect detection model and a second defect detection model, respectively, and extracting a first feature map output by a target convolutional layer in the first defect detection model and a second feature map output by a corresponding target convolutional layer in the second defect detection model, respectively, wherein the second defect detection model is a deep convolutional neural network model that has the same general architecture as the pre-trained first defect detection model but with fewer layers;
calculating distances between corresponding feature vectors in the first feature map and the second feature map, and using corresponding elements in the segmentation labeling factor matrix to correct the distances, so as to obtain corrected distances between corresponding feature vectors in the first feature map and the second feature map, and calculating a sum of the corrected distances between all the feature vectors in the first feature map and the second feature map as a first loss function; and
performing iterative training on the second defect detection model, on the basis of minimizing the first loss function, so as to obtain a distilled second defect detection model.

2. The compression training method for the defect detection model according to claim 1, wherein the segmentation labeling factor matrix is configured to label factor values corresponding to individual pixel points in each sample image, wherein the factor values for pixel points in the defect area of each sample image and the factor values for pixel points in a non-defect area of each sample image are opposite numbers to each other.

3. The compression training method for the defect detection model according to claim 2, wherein the step of calculating distances between corresponding feature vectors in the first feature map and the second feature map, and using corresponding elements in the segmentation labeling factor matrix to correct the distances, so as to obtain corrected distances between corresponding feature vectors in the first feature map and the second feature map comprises:
calculating a squared Euclidean distance of respective normalized vectors of corresponding feature vectors of the first feature map and the second feature map; and
calculating a product of the squared Euclidean distance and a corresponding element in the segmentation labeling factor matrix, so as to obtain the corrected distance between corresponding feature vectors of the first feature vector and the second feature vector.

4. The compression training method for the defect detection model according to claim 3, wherein the step of calculating a product of the squared Euclidean distance and a corresponding element in the segmentation labeling factor matrix, so as to obtain the corrected distance between corresponding feature vectors of the first feature vector and the second feature vector comprises:
performing a size transformation operation on the segmentation labeling factor matrix, so as to obtain a transformed segmentation labeling factor matrix after alignment with sizes of the first feature map and the second feature map; and
calculating a product of the squared Euclidean distance and a corresponding element in the transformed segmentation labeling factor matrix, so as to obtain the corrected distance between corresponding feature vectors of the first feature map and the second feature map.

5. The compression training method for the defect detection model according to claim 4, further comprising:
after inputting each sample image into the second defect detection model, obtaining a defect classification probability vector output by the second defect detection model;
calculating a cross entropy loss between the defect classification probability vector and a classification labeling vector of the sample image, as a second loss function; and
calculating a weighted sum of the first loss function and the second loss function as a total loss function, and performing iterative training on the second defect detection model, on the basis of minimizing the total loss function, so as to obtain the distilled second defect detection model.

6. The compression training method for the defect detection model according to claim 5, further comprising: calculating, for a plurality of sample images of each batch in the sample image dataset, an average value of the total loss function of each sample image input into the first defect detection model and the second defect detection model, and performing iterative training on the second defect detection model, on the basis of minimizing the average value of the total loss function.

7. The compression training method for the defect detection model according to claim 6, further comprising: if the first feature map and the second feature map are inconsistent in size, performing downsampling on the first feature map or performing upsampling on the second feature map, so as to align the first feature map and the second feature map in size.

8. A compression training method for a defect detection model, comprising:
performing segmentation labeling of a defect area on a sample image dataset of a product appearance, so as to obtain a segmentation labeling factor matrix of each sample image;
inputting each sample image in the sample image dataset into a first defect detection model and a second defect detection model, respectively, and extracting a plurality of first feature maps output by a plurality of target convolutional layers in the first defect detection model and a plurality of second feature maps output by a plurality of corresponding target convolutional layers in the second defect detection model, respectively, wherein the second defect detection model is a deep convolutional neural network model that has the same general architecture as the pre-trained first defect detection model but with fewer layers;
calculating distances between corresponding feature vectors in each first feature map and corresponding second feature map among the plurality of first feature maps and second feature maps in sequence, and using corresponding elements in the segmentation labeling factor matrix to correct the distances, so as to obtain corrected distances between corresponding feature vectors in each first feature map and corresponding second feature map, calculating a sum of the corrected distances between all feature vectors in each first feature map and corresponding second feature map, and calculating an accumulation of the sum of the corrected distances between each first feature map and corresponding second feature map among the plurality of first feature maps and second feature maps as a first loss function; and
performing iterative training on the second defect detection model, on the basis of minimizing the first loss function, so as to obtain a distilled second defect detection model.

9. A compression training apparatus for a defect detection model, comprising:
a segmentation labeling unit, configured to perform segmentation labeling of a defect area on a sample image dataset of a product appearance, so as to obtain a segmentation labeling factor matrix of each sample image;
a feature extraction unit, configured to input each sample image in the sample image dataset into a first defect detection model and a second defect detection model, respectively, and extract a first feature map output by a target convolutional layer in the first defect detection model and a second feature map output by a corresponding target convolutional layer in the second defect detection model, respectively, where the second defect detection model is a deep convolutional neural network model that has the same general architecture as the pre-trained first defect detection model but with fewer layers;
a first loss evaluation unit, configured to calculate distances between corresponding feature vectors in the first feature map and the second feature map, and use corresponding elements in the segmentation labeling factor matrix to correct the distances, so as to obtain corrected distances between corresponding feature vectors in the first feature map and the second feature map, and calculate a sum of the corrected distances between all feature vectors in the first feature map and the second feature map as a first loss function; and
a first iterative training unit, configured to perform iterative training on the second defect detection model, on the basis of minimizing the first loss function, so as to obtain a distilled second defect detection model.

10. (canceled)
